(19) United States
(12) Patent Application Publication
(10) Pub. No.: US 2005/0060551 A1
(43) Pub. Date: Mar. 17, 2005

(54) Terminal device IP address authentication

(76) Inventors: Ronald S. Barchi, Maple Valley, WA (US); Krishna Bhuyan, Redmond, WA (US)

Correspondence Address: Charles A. Mirho, 112 W. 37th St., Vancouver, WA, 98660, US

(21) Appl. No.: 10/662,656

(22) Filed: Sep. 15, 2003

(51) Int. Cl. H04K 1/00

(52) U.S. Cl. 713/182

(57) ABSTRACT

A code is received from a terminal device in lieu of a user name and password. A subscriber identifier corresponding to an IP address of the terminal device is located. Subscriber information corresponding to the identifier is located, and it is determining whether a subscriber has access to a requested service.

### TECHNICAL FI LD

The present disclosure relates to authentication of devices on a network.

### BACKGROUND

Wireless telephones are popular, ubiquitous devices. It is now possible to make and receive phone calls from almost any place in the world. Communication is even possible from remote and undeveloped areas using wireless satellite telephones. Herein, the term wireless telephone refers to any device capable of transmitting and receiving voice and/or data (non-voice) information to and from a network without the use of wires, cables, or other tangible transmission media. So-called cellular telephones are a common example of wireless phones.

Wireless telephones and the networks by which they communicate operate according to various technologies, including analog mobile phone service (AMPS), circuit switching, packet switching, wireless local area network (WLAN) protocols such as IEEE 802.11 compliant networks, wireless wide-area networks (WWAN), short-range RF systems such as Bluetooth, code division multiple access (CDMA), time division multiple access (TDMA), frequency-division multiplexing (FDM), spread-spectrum, global system for mobile communications (GSM), high-speed circuit-switched data (HCSD), general packet radio system (GPRS), enhanced data GSM environment (EDGE), and universal mobile telecommunications service (UMTS). Of course, these are only examples, and other technologies may be employed in wireless communication as well.

Herein, the term ‘wireless device’ is meant to include wireless telephones (including cellular, mobile, and satellite telephones), and also to include a variety of other wireless devices, including wireless web-access telephones, automobile, laptop, and desktop computers that communicate wirelessly, and wireless personal digital assistants (PDAs). In general, the term ‘wireless device’ refers to any device with wireless communication capabilities.

Many companies produce wireless telephones and other wireless devices. Among the more well-known producers are Nokia®, Ericsson®, Motorola®, Panasonic®, Palm® Computer, and Handspring®. A variety of producers also provide wireless devices comprising versions of the Microsoft® Windows® operating software.

Modern wireless devices may accept a subscriber identity module (SIM). The SIM identifies a subscriber of the network by which the wireless device communicates. A “subscriber” represents one or more persons or entities (corporations, partnerships, agents, operators, etc.) with access privileges to the network. A subscriber may be or represent a single user, or may represent one or more users. “User” refers to any person (or, conceivably, autonomous or semi-autonomous logic) with access privileges to the network. Typically the user is the operator of a terminal device, although a user could also be the operator of a device or devices that provide services via the network.

“Terminal device” refers to any device employed by a user (typically a person but also possibly an autonomous or semi-autonomous device system) to access the network environment.

A “service” is information and acts available via the network. Examples of services include Short Message Service (SMS), email, and stock quotes. A “service provider” is any device or combination of devices that provides services via the network environment. Typically, a service provider provides information delivery to terminal devices, and/or performs network actions in response to requests from terminal devices. A service provider may also provide information delivery and/or network actions on behalf of another service provider.

A service may have associated terminal device logic. The terminal device logic may operate on the terminal device to enable access to the service. This logic may be referred to as a “client”. For example, an email service of the network may have associated terminal device logic, referred to as an email client, that operates on the terminal device to enable access to a subscriber's email account. A service may require that a subscriber authenticate themselves before accessing the service. Authentication may involve the communication of identifying information, known as subscriber credentials, from the client to the service provider.

A subscriber may access different services from a terminal device. Each service may require subscriber authentication and the tedious process of setting up a subscriber account with the service provider. The effort and complexity involved may discourage a subscriber from accessing a number of services. This may be particularly the case for new subscribers who are attempting to access services for the first time.

### SUMMARY

The present invention provides benefits over the prior art. A brief summary of some embodiments and aspects of the invention are first presented. Some simplifications and omissions may be made in the following summary; the summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the Figures, and from the claims (which follow the detailed description).

A code is received from a terminal device in lieu of a user name and password. A subscriber identifier corresponding to an IP address of the terminal device is located. Subscriber information corresponding to the identifier is located, and it is determining whether a subscriber has access to a requested service.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a wireless communication arrangement.

FIG. 2 is a more detailed block diagram of an embodiment of a wireless communication arrangement.

FIG. 3 is a block diagram of an embodiment of a SIM.

FIG. 4 is a flow chart of an embodiment of acts of authenticating and authorizing a device to access services of a network.

FIGS. 5-7 are block diagrams of embodiments of portions of a network environment.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

Herein, “logic” refers to any information having the form of instruction signals and/or data that may be applied to affect the operation of a processing device. Examples of processing devices are computer processors (processing units), microprocessors, digital signal processors, controllers and microcontrollers, and so on. Logic may be formed from signals stored in a device memory. Software is one example of such logic. Examples of device memories that may comprise logic include RAM (random access memory), flash memories, ROMS (read-only memories), EPROMS (erasable programmable read-only memories), and EEPROMS. Logic may also be comprised by digital and/or analog hardware circuits, for example, hardware circuits comprising logical AND, OR, XOR, NAND, NOR, and other logical operations. Logic may be formed from combinations of software and hardware.

“Information” is configurations of matter representing knowledge, e.g. “data”. Examples of information are collections of magnetic or optical bits.

A “network element” is any one or more devices of a communication network, e.g. devices that participate at least occasionally in the operation of the network.

Typically, a subscriber will enter into contractual arrangements with a network operator for access rights to the operator's network(s). Networks of this operator for which the subscriber has contractual access rights are the subscriber's “home networks.” Networks other than the home networks of the subscriber are “roaming networks.” The subscriber and the subscriber's wireless device are said to be “roaming” when accessing a roaming network.

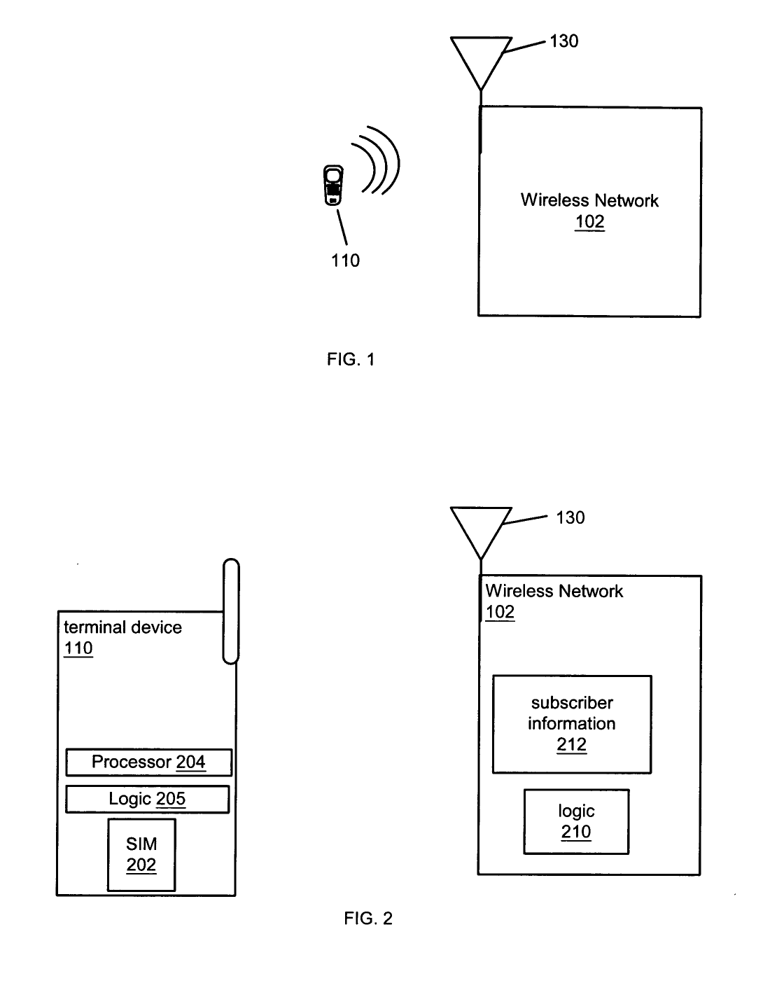

FIG. 1 is a block diagram of an embodiment of a wireless communication arrangement. A terminal device 110 communicates with a network 102. The network 102 receives signals from the terminal device 110 via an antennae 130.

FIG. 2 is a more detailed block diagram of an embodiment of a wireless communication arrangement. The terminal device 110 comprises a processor 204, logic 205, and a subscriber identity module (SIM) 202.

The terminal device 110 comprises a processor 204 and logic 205. The logic 205, when applied to the processor, may cause the terminal device 110 to carry out acts of and in accordance with the methods described herein.

The SIM 202 and the terminal device 110 may be coupled in such a manner that the two may be easily coupled and decoupled. For example, the SIM 202 may insert into a slot in the terminal device 110. A subscriber of the network may remove the SIM 202 from the terminal device 110 and couple it to another terminal device. Likewise, another subscriber may replace the SIM 202 in the device with another SIM representing the other subscriber.

The network 102 comprises subscriber information 212 and logic 210. Subscriber information 212 may comprise such information as a subscriber id, payment parameters, service provision information, service delivery information, billing and settlement information, access network information, and security and access control information.

The logic 210 may cause the network 102 to carry out acts of and in accordance with the methods described herein.

The subscriber id identifies a subscriber from among subscribers to the network. Payment parameters describe the manner and terms of payment. Examples are monthly subscription charges, flat-fee arrangements, per-use arrangements, pre-paid amounts, and so on. Service provision information describes a level or package of services available to the subscriber. Examples are premium, standard, and basic. Service delivery information describes a level of service available to the subscriber from the network. Examples include 100 Mbps (megabit per second) service, and guaranteed information delivery. Billing information describes how the subscriber is to be charged. This information may include the subscriber's billing address, credit or debit card information, and/or account numbers. Settlement information describes information about current charges to the subscriber. Examples include information about the subscriber's current charges, and due and past-due charges. Access network information describes the manners of network access the subscriber may employ. Examples include GPRS, 2G, 3G, and circuit switching. Security information describes how the subscriber may protect information communicated to or from the network. Examples are digital signature and encryption key information. Access control information describes how the subscriber may access information and/or acts available via the network to which access is controlled. Examples include id and password information.

The subscriber information 212 may comprise information about services available to the subscriber, e.g. those services which the subscriber is authorized to access. Services may be characterized by service information, including a service identifier, a service type, a service description, service requirements, performance requirements, quality of service information, network resource requirement information, network resource allowance information, and security and access control information.

The service identifier identifies the service from among services available via the network. The service type identifies the type of service, e.g. business, consumer, entertainment, etc. The service description describes the service, such as “Real-Time Stock Quotes”. Service requirements describe requirements for the service to be properly provided. For example, service requirements may include information about the graphics, processor, memory, communications, payment capacity, and other requirements that a device, and/or user, and/or subscriber should meet in order for the service to be provided. The service requirement information may be organized according to categories, such as graphics, processor, memory, and communications. Of course these are merely examples of possible categories. The categories may be defined to correspond with the categories of the device information 206. For example, the graphics category may comprise information about the graphics requirements to properly render the service information, information such as the display size, graphics processor, and colors that a device should employ to properly render the service to the user. The processor category may comprise information about the processing capabilities that need be employed by a device to properly receive and render the service (e.g. processor speed). The memory category may comprise information about the memory requirements to properly receive and render the service on a device (e.g. minimum available memory, memory speed). The communication category may comprise information about the communication requirements to properly receive and render the service on a device (e.g. bandwidth, codec).

Quality of service information describes the quality of service that the service requires from the network. Network resource requirement information describes the network resources that need be allocated in order to carry out the actions of the service. For example, the network resource requirement information may comprise bandwidth and memory allocation requirements. Network resource requirements may also include a relay server address and WAP gateway information, among other things. The network allowance information describes the network resources actually made available to carry out the actions of the service. For example, a streaming video service may require 10 Mbps of network bandwidth to deliver streaming video to terminal devices. However only 1 Mbps of bandwidth may be allowed. Security information describes how the information of the service is protected during communication over the network. Examples are digital signature and encryption key information.

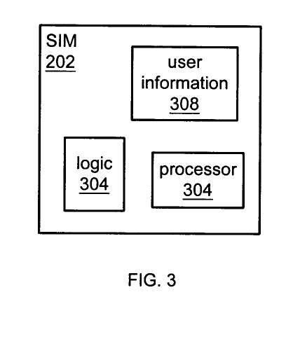

FIG. 3 is a block diagram on an embodiment 202 of a SIM. The SIM 202 comprises user information 308, logic 304, and a processor 306.

The logic 304, when applied to the processor 306, may cause the SIM 202 to carry out acts of and in accordance with the methods described herein.

The user information 308 may comprise information such as a user id, media delivery preferences, presence information, usage information, demographic information, association information, and personalization information.

The user id identifies a user from among users of the network. Media delivery preferences include information about the manner in which information should be communicated to the user. Examples include frame rate, color schemes, visual quality, and visual layout. Usage information comprises information about the user's access to the network environment, possibly including how, when, how often, and for what purpose the user accessed the network environment. Usage information may include information about which services a user accesses and/or how often, and/or the most recently used and/or most frequently accessed services. The usage information may also comprise information about trends and patterns in the user's usage behavior.

Personal information describes a user. Examples are the user's name and address, as well as a user's privacy information (restrictions on distribution of the user profile information). Demographic information may be used to classify a user for statistical, marketing, or other purposes. Examples include the user's age, race, and gender. Association information describes other users and/or subscribers that have an association with the user. The association information may also describe the nature of the association. Examples include associates, family members, and patrons.

Personalization information describes a user's preferred, most recent, and/or most frequent settings for services that the user may access. Examples include a user's preferred type of news information (sports, local events, etc.) and a user's most frequent and/or most recent search queries.

Security information describes how the user may protect information communicated to or from the network. Examples are digital signature and encryption key information. In various embodiments the subscriber security information may be applied to protect the communications of the users associated with the subscriber. Alternatively, or in addition, the user security information may be applied to protect the communications of the users associated with the subscriber, independent of one another.

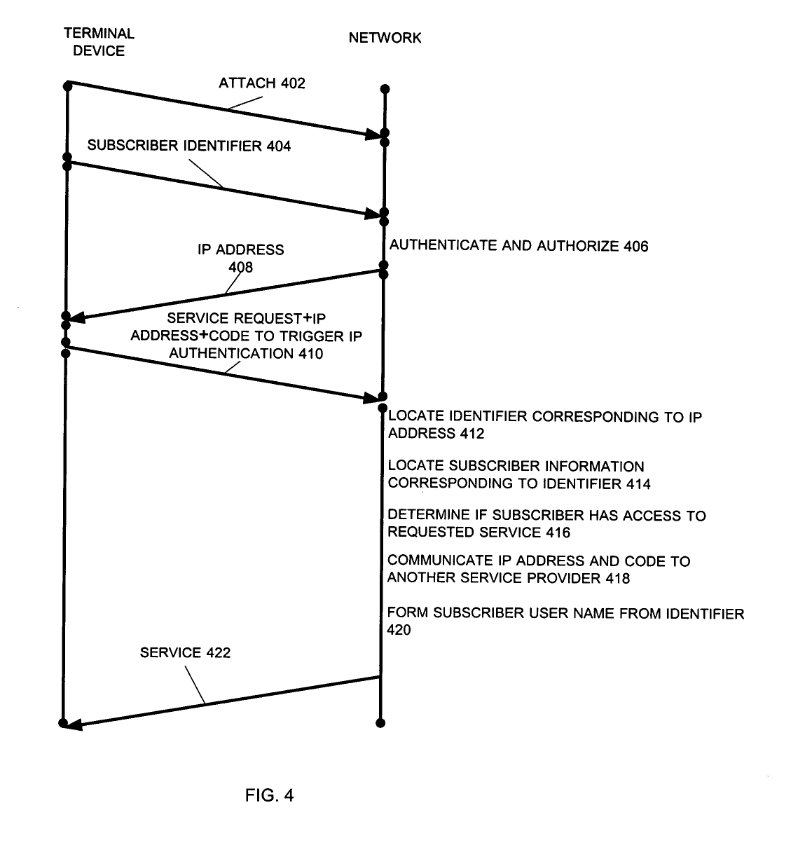

FIG. 4 is an action diagram of an embodiment of a method of authenticating and authorizing a subscriber to access a service. At 402 the device “attaches” to the network. Attaching involves an exchange of information with the network, such that the network recognizes the device and/or user of the device as authorized to use the network. For example, a wireless phone may attach to the network when the phone is powered on within wireless communication range of the network.

As part of the process of attaching to the network, the device may, at 404, communicate an identification of the subscriber and/or user to the network. An example of such an identification is the Mobile Station (or Subscriber) Integrated Services Digital Network (MSISDN) number. Other examples are the Mobile Station Roaming Number (MSRN) and the International Mobile Subscriber Identity (IMSI). At 406 the network authenticates and authorizes the user/subscriber using the provided identification. Once authentication/authorization is complete, the network at 408 communicates an Internet Protocol (IP) address to the terminal device. The terminal device may employ the IP address to communicate with and receive services from the network.

The terminal device, independently or at the behest of a user/subscriber, may request a service of the network. Often client logic associated with the service is involved in making a service request. At 410 a service request is communicated to the network. The terminal device's IP address is also communicated to the network. In prior art techniques the terminal device might also communicate to the network a user/account name and password combination that was unique to the user/subscriber. The network would employ this information to authenticate/authorize access to the requested service.

In one embodiment a code is communicated to the network in lieu of unique authentication credentials. The code is any information that is recognized by the network to trigger an authentication process of the source of the service request. For example, the code could be a ‘generic’ user name, password, or user name and password combination that is common to multiple (or all) users and/or subscribers of the network. Receiving the code causes the network to authenticate and authorize the user/subscriber for the service request, based upon the authentication at 406 when the device attached to the network.

At 412 the network locates the identifier corresponding to the IP address assigned to the device. In one embodiment the identifier may be located by communicating the IP address to a RADIUS protocol compliant server, which in return provides the corresponding MSISDN. At 414 the network may locate subscriber information corresponding to the identifier. In one embodiment the subscriber information is located by providing the MSISDN to a Home Location Registry (HLR) or Visitor Location Registry (VLR) of the network. At 416 the subscriber information is examined to determine whether the user/subscriber originating the service request has access to the requested service.

In some situations, the service provider that the service request is directed to may enlist the services of another provider. For example, an email provider may enlist the services of a streaming video provider when an email contains a video attachment. The other provider may also require authentication of the user/subscriber. The service provider may communicate the IP address and code to the other provider, to cause the other provider to authenticate the user/subscriber for the other service, based upon the authentication at 406 when the device attached to the network.

At 420 the service provider may identify or create an account of the user/subscriber according to the identifier. For example, the service provider may form an account name using the MSISDN of the user/subscriber. Thus, the user/subscriber need not provide a username and/or password for the account, reducing the complexity of setting up access to, and accessing, the service.

At 422 the network provides the service to the terminal device. The user/subscriber is authenticated and authorized without involving complex account set-up or communication of unique user name and password.

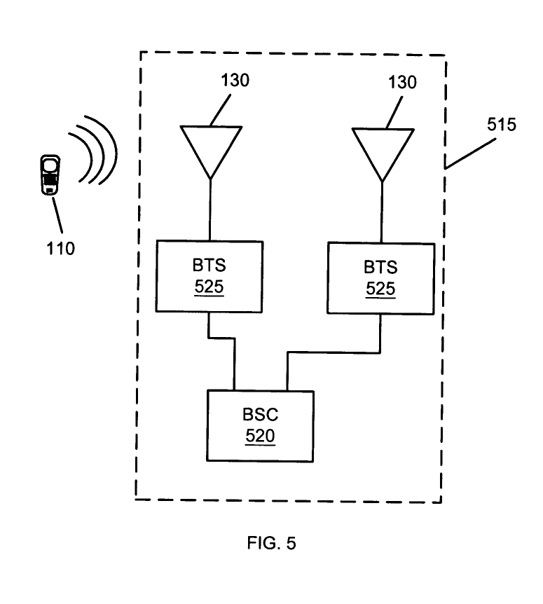

Embodiments of a wireless network will now be described in conjunction with FIGS. 5-7. In the description, particular network elements are identified that may comprise the subscriber information 212 and logic 210 to carry out acts described herein. These network elements are identified by way of example and not limitation, e.g. the subscriber information 212 and the logic 210 may be comprised by network elements other than those specifically identified in the figures.

FIG. 5 shows a block diagram of the base station subsystem of a wireless network. The base station subsystem (BSS) 515 consists of base station controllers (BSC) 520 coupled to one or more base transceiver stations (BTS) 525. In turn, each BTS 525 is coupled to one or more antennae 130.

The BTS 525 includes transmitting and receiving equipment to create a radio interface between the wireless network and terminal devices. Although the antennae 130 is shown as a separate element for clarity, it is common in the industry to collectively refer to the antennae 130, transmitter, and receiver, as the BTS.

The BSC 520 may perform management of the radio interface by allocating channels, managing handover from one BTS to another, paging the wireless device, and transmitting connection-related signaling data.

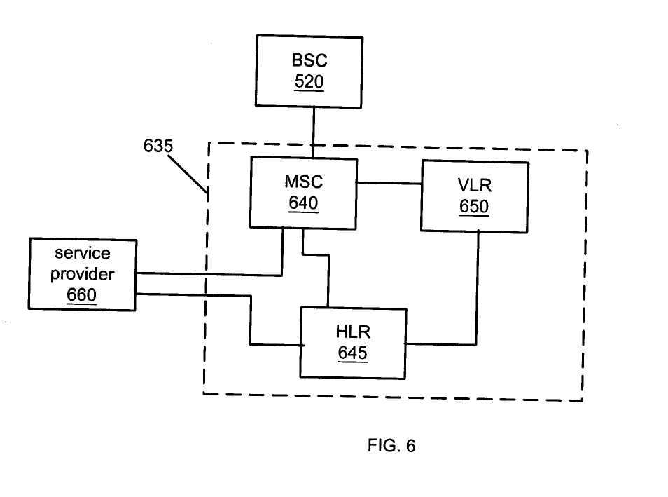

FIG. 6 is a block diagram of the networking and switching subsystem (NSS) 635 of a wireless network. The NSS 635 comprises a Mobile Switching Center (MSC) 640, a Home Location Registry (HLR) 645, and a Visitor Location Registry (VLR) 650. Switching and network management functions are carried out by the NSS 635. The NSS 635 may also act as a gateway between the wireless network and other networks such as the Public Switched Telephone Network (PSTN), Integrated Services Digital Network (ISDN), the Internet, other wireless networks, and the Public Data Network (PDN).

The MSC 640 is a digital switching mechanism that routes communications and manages the network. In GPRS networks, GPRS support nodes (GSNs) such as Switching GSNs (SGSNs) and Gateway GSNs (GGSNs) may provide switching operations similar to those provided by the MSC 640. There can be many MSC (switches) 640 in a communication network, each responsible for the signaling required to set up, maintain, and terminate connections to wireless devices within the geographical area served by the MSC 640. Each MSC 640 may manage several BSC 520. The MSC 640 is coupled to a Home Location Registry (HLR) 645 and a Visitor Location Registry (VLR) 650. The HLR 645 is also coupled to the VLR 650.

In one embodiment, at least part of the subscriber information 212 is comprised by the HLR 645. Also, the HLR 645 may comprise certain dynamic or temporary subscriber data such as current Location Area (LA) of the subscriber's mobile station and Mobile Station Roaming Number (MSRN). Subscriber-related data is recorded in the HLR 645 from which billing and administrative information is extracted when needed by the cellular service provider. Some wireless networks have only one HLR 645 that serves all subscribers; others have multiple HLRs.

The MSC 640 uses the VLR 650 to manage the wireless devices that are currently roaming in the area controlled by the MSC 640. The VLR 650 stores information such as the International Mobile Subscriber Identity (IMSI), authentication data, and telephone number of the roaming wireless devices. The VLR 650 may obtain and comprise subscriber information, such as information about the services to which a roaming user is entitled, from the HLR that serves the wireless device. The VLR 650 controls a pool of MSRN and allocates an MSRN and TMSI to the roaming wireless device. The VLR 650 sends the MSRN and Temporary Mobile Subscriber Identity (TMSI) information to the HLR 645 where they are stored with the subscriber's dynamic records for later use in call routing.

In one embodiment the VLR 650 comprises at least part of the subscriber information for the users of wireless devices that are roaming the network 102.

A service provider 660 is coupled to the MSC 640 and HLR 645. The service provider 660 provides one or more services to terminal devices, such as email, stock quotes, video streaming, and so on.

In one embodiment, the MSC 640 comprises at least part of the logic 210 to locate a user/subscriber identifier (such as an MSISDN) corresponding to an IP address (or to cause the identifier to be located by communicating with another network element, such as a RADIUS server); to locate subscriber information corresponding to the identifier (or to cause the subscriber information to be located by communicating, for example, with an HLR or VLR); to determine if a user/subscriber has access to a requested service (or to cause such a determination by communicating, for example, with an HLR or VLR); and to communicate the IP address and code to other network elements as needed to fulfill a service request.

In one embodiment, the service provider 660 comprises at least part of the logic 210 to locate a user/subscriber identifier (such as an MSISDN) corresponding to an IP address (or to cause the identifier to be located by communicating with another network element, such as a RADIUS server); to locate subscriber information corresponding to the identifier (or to cause the subscriber information to be located by communicating, for example, with an HLR or VLR); to determine if a user/subscriber has access to a requested service (or to cause such a determination by communicating, for example, with an HLR or VLR); and to communicate the IP address and code to other network elements as needed to fulfill a service request. The service provider 660 may also comprise logic to form a username/account name from the user/subscriber identifier.

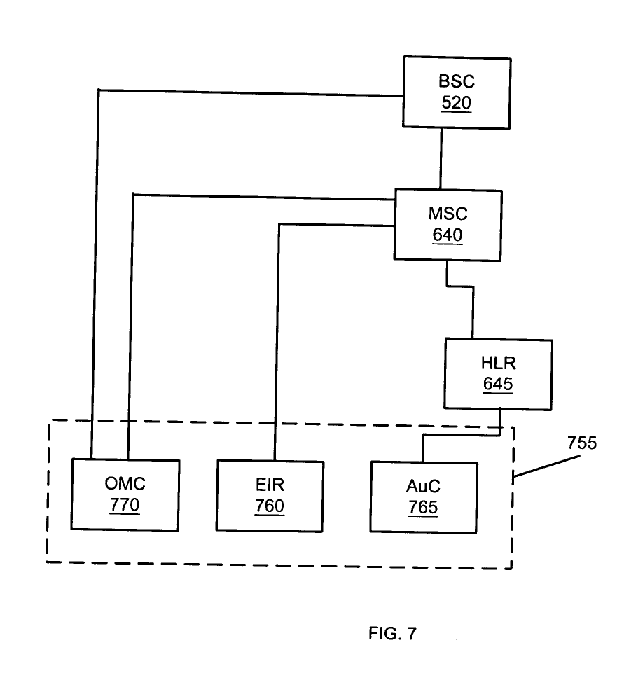

FIG. 7 is a block diagram of the operation subsystem (OSS) 755 of a network 102. The OSS 755 includes an Equipment Identity Register (EIR) 760, an Authentication Center (AuC) 765, and an Operating and Maintenance Center (OMC) 770. The OSS 755 may provide subscription management, network operation, network maintenance, and mobile equipment management. The OSS 755 extracts call data from the HLR 645 in order to bill the subscriber.

The AuC 765 stores data related to network security and authentication of wireless devices and subscribers. The primary purpose of AuC 765 is to prevent fraud by verifying the identity of wireless devices and subscribers that try to access the network. Thus the AuC 765 may comprise authentication algorithms and encryption codes necessary to protect a subscriber's access rights and identity and to prevent eavesdropping.

The EIR 760 is a database which stores subscriber and International Mobile Equipment Identity (IMEI) numbers. Wireless devices are uniquely identified by an IMEI or equivalent number such as an Electronic Serial Number (ESN). An EIR 760 generally indicates the status of a particular wireless device by flags associated with its IMEI. An IMEI is typically flagged as one of either valid, stolen, suspended, or malfunctioning.

The OMC 770 monitors and controls other network elements to enhance system performance and quality. The OMC 770 also administers billing, subscriber service data, and generation of statistical data on the state and capacity of the network.

In one embodiment, one or more of the AuC 765, EIR 760, and OMC 770 may comprise at least part of the subscriber information 212. In one embodiment, one or more of the AuC 765, EIR 760, and OMC 770 comprises at least part of the logic 210 to locate a user/subscriber identifier (such as an MSISDN) corresponding to an IP address (or to cause the identifier to be located by communicating with another network element, such as a RADIUS server); to locate subscriber information corresponding to the identifier (or to cause the subscriber information to be located by communicating, for example, with an HLR or VLR); to determine if a user/subscriber has access to a requested service (or to cause such a determination by communicating, for example, with an HLR or VLR); and to communicate the IP address and code to other network elements as needed to fulfill a service request.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

1. A device comprising:
a processor; and
logic which, when applied to the processor in response to receiving a service request, results in
locating a subscriber identifier corresponding to an IP address;
locating subscriber information corresponding to the identifier; and
determining whether a subscriber has access to a requested service.

2. The device of claim 1 further comprising:
logic which, when applied to the processor, results in the acts of claim 1 in response to receiving a code from a terminal device, the code indicating that a unique username and password will not be provided by the terminal device.

3. The device of claim 2 further comprising:
logic which, when applied to the processor, results in communication of the code and IP address to a service provider.

4. The device of claim 1 further comprising:
logic which, when applied to the processor, results in forming an account name from the identifier.

5. The device of claim 1 wherein the identifier is an MSISDN.

6. The device of claim 5 further comprising:
logic which, when applied to the processor, results in querying a RADIUS server to locate the subscriber identifier corresponding to the IP address.

7. A terminal device comprising:
a processor; and
logic which, when applied to the processor, results in
communicating to a network, in lieu of a user name and password, a code to cause the network to authenticate and authorize access to a service, the authentication and authorization based upon an IP address assigned to the terminal device by the network and upon a unique identifier provided by the terminal device to the network during an earlier attach process.

8. The terminal device of claim 7 further comprising:
client logic associated with a service provider, which, when applied to the processor to access the service provider, results in communicating the code and IP address to the network in lieu of communicating a user name and password.

9. A method comprising:
receiving a code from a terminal device in lieu of a user name and password;
locating a subscriber identifier corresponding to an IP address of the terminal device;
locating subscriber information corresponding to the identifier; and
determining whether a subscriber has access to a requested service.

10. The method of claim 9 further comprising:
communicating the code and IP address to at least one service provider to obtain authorization for the services of the at least one service provider.

11. The method of claim 9 further comprising:
forming from the identifier an account name for the subscriber.

12. The method of claim 9 wherein the identifier is an MSISDN.

13. The method of claim 12 further comprising:
querying a RADIUS server to locate the MSISDN corresponding to the IP address.
